(19) United States
(12) Patent Application Publication
(10) Pub. No.: US 2025/0096717 A1
(43) Pub. Date: Mar. 20, 2025

(54) SOLAR POWERED ELECTRICITY GENERATING TABLE

(71) Applicants: Jeff HIller, Newbury Park, CA (US); Kathy Baker, Newbury Park, CA (US)

(72) Inventors: Jeff HIller, Newbury Park, CA (US); Kathy Baker, Newbury Park, CA (US)

(21) Appl. No.: 18/369,651

(22) Filed: Sep. 18, 2023

(51) Int. Cl. H02S 10/40; A47B 13/08; H02J 7/00; H02J 7/35; H02S 10/20

(52) U.S. Cl. CPC H02S 10/40; A47B 13/08; H02J 7/0042; H02J 7/35; H02S 10/20

(57) ABSTRACT

A support apparatus for generating, storing, and discharging electrical power includes a table with a tabletop and a plurality of legs. The plurality of legs is coupled to and extends downwardly from the tabletop. The tabletop has an upper surface which is planar and is configured for supporting items. A solar panel is coupled to the table and is positioned on the tabletop. The solar panel has a top surface which is coplanar with the upper surface of the tabletop and is positioned in a corner of the tabletop. A power storage is electrically coupled to the solar panel. A charging assembly is electrically coupled to the power storage and is mounted to the tabletop. The charging assembly comprises a charging port.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tables and more particularly pertains to a new table for generating, storing, and discharging electrical power.

### (2) Description of Related Art Including Information Disclosed Under 37 CFR 1.97 and 1.98

The prior art discloses myriad solar powered electrical generators which are attached to tables or other support apparatuses. However, the prior art fails to describe such a device which integrates multiple spaced solar panels into a tabletop of a table near a perimeter wall of the tabletop so that a center portion of the tabletop may be used without obscuring the solar panels. Such an apparatus facilitates continued power generation while using the center portion of the tabletop.

### BRIEF SUMMARY OF THE INVENTION

An embodiment of the disclosure meets the needs presented above by generally comprising a table with a tabletop and a plurality of legs. The plurality of legs is coupled to and extends downwardly from the tabletop. The tabletop has an upper surface which is planar and is configured for supporting items. A solar panel is coupled to the table and is positioned on the tabletop. The solar panel has a top surface which is coplanar with the upper surface of the tabletop and is positioned in a corner of the tabletop. A power storage is electrically coupled to the solar panel. A charging assembly is electrically coupled to the power storage and is mounted to the tabletop. The charging assembly comprises a charging port.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a support apparatus according to an embodiment of the disclosure.

FIG. 2 is a bottom perspective view of an embodiment of the disclosure.

FIG. 3 is an exploded in-use view of an embodiment of the disclosure.

FIG. 4 is a top view of an embodiment of the disclosure.

FIG. 5 is a block diagram of an embodiment of the disclosure.

FIG. 6 is an in-use view of an embodiment of the disclosure.

### DETAILED DESCRIPTION OF THE INVENTION

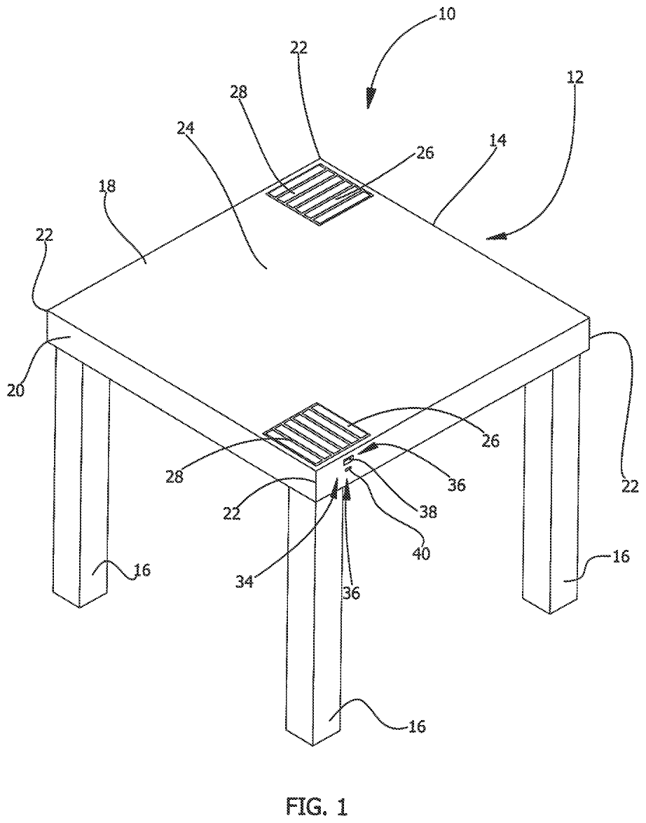

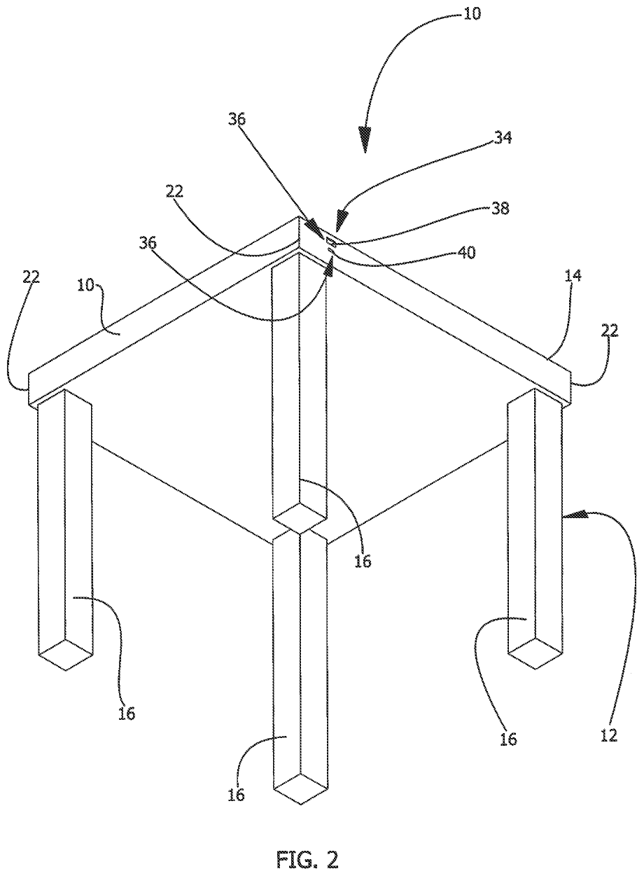

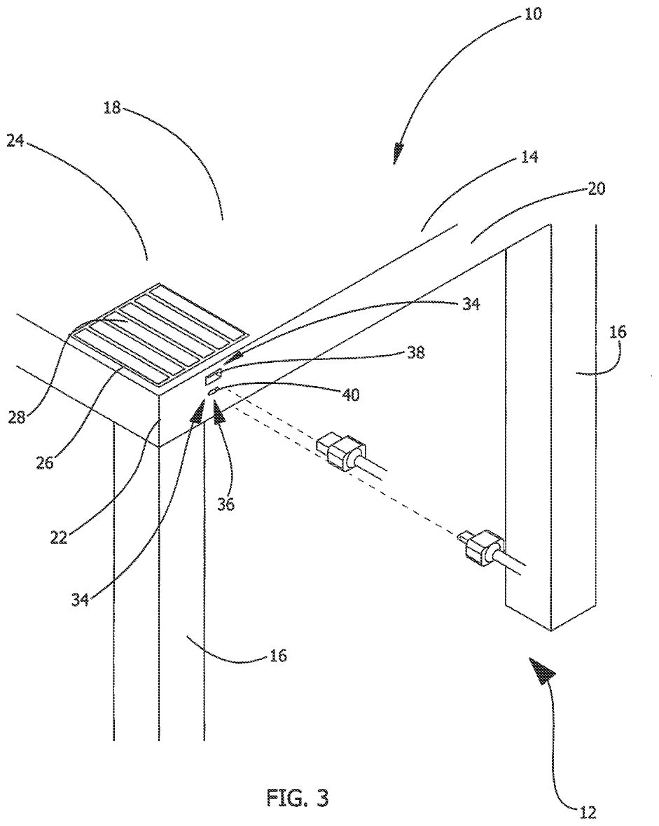

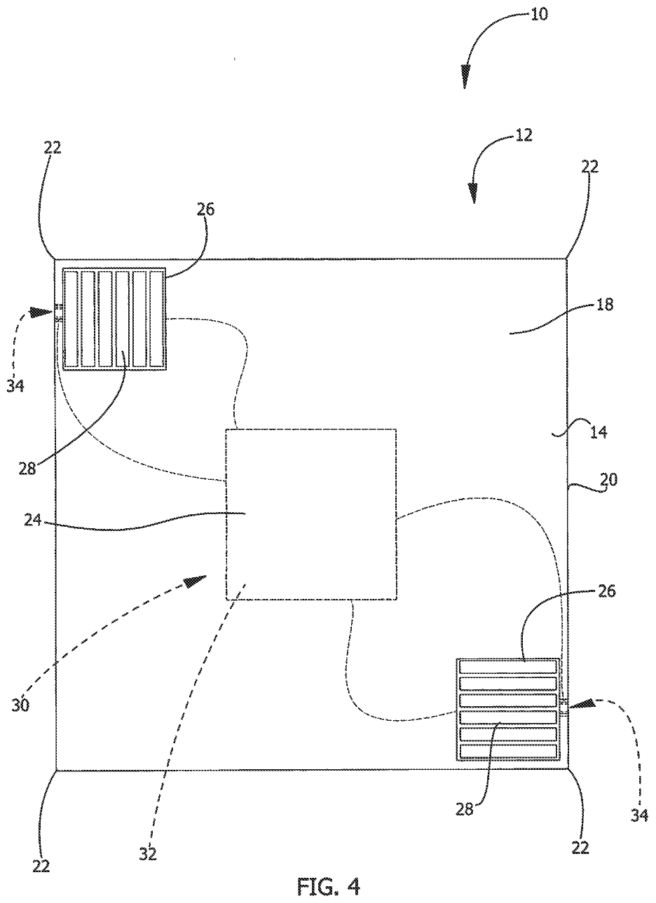

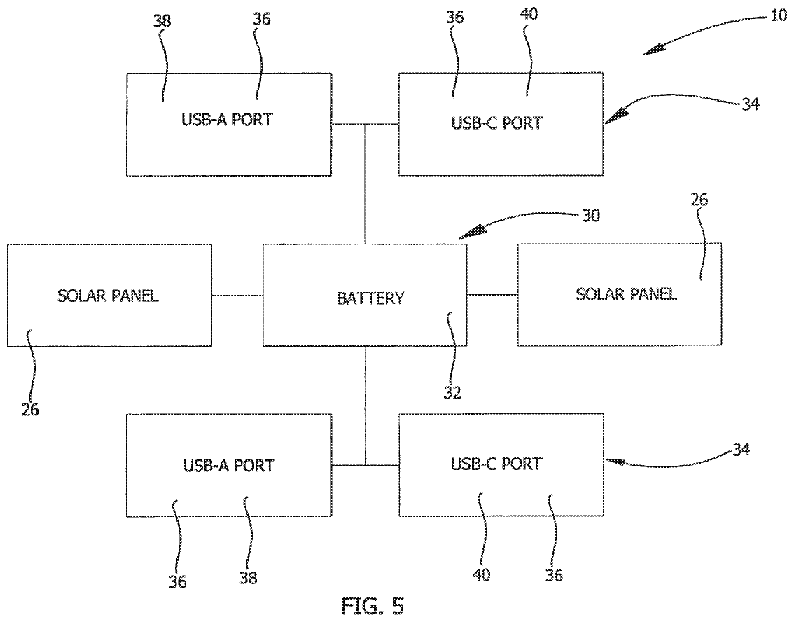

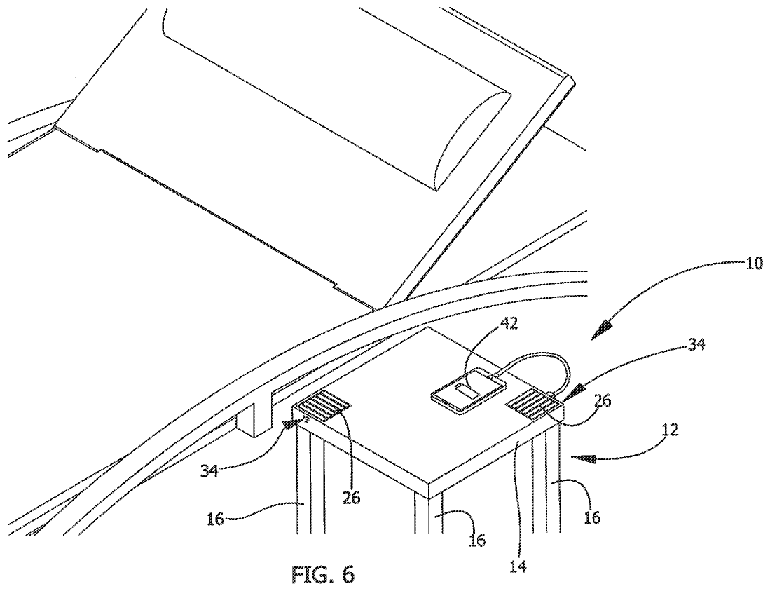

With reference now to the drawings, and in particular to FIGS. 1 through 6 thereof, a new table embodying the principles and concepts of an embodiment of the disclosure and generally designated by the reference numeral 10 will be described.

As best illustrated in FIGS. 1 through 6, the support apparatus 10 generally comprises a table 12 which has a tabletop 14 and a plurality of legs 16. The plurality of legs 16 is coupled to and extends downwardly from the tabletop 14. The tabletop 14 has an upper surface 18 which is configured for supporting items. The upper surface 18 is planar and has a square shape. Other shapes may be used as befits the space in which the support apparatus 10 is intended to be used.

A pair of solar panels 26 is coupled to the table 12. Each solar panel 26 of the pair of solar panels 26 is positioned on the tabletop 14 and has a top surface 28 which is coplanar with the upper surface 18 of the tabletop 14. The solar panels 26 are positioned in opposing corners 22 of the tabletop 14. A width of each solar panel 26 is less than 25.0% of a width of the upper surface 18 of the tabletop 14, and a length of each solar panel 26 taken perpendicularly to the width of the solar panel 26 is less than 25.0% of a length of the upper surface 18 of the tabletop 14 taken perpendicularly to the width of the upper surface 18.

The positioning and size of the solar panels 26 allows for a center portion 24 of the tabletop 14 to be used without obscuring the solar panels 26 to allow the solar panels 26 to generate electricity while the support apparatus 10 is used to support items. The positioning and size of the solar panels 26 also permits some items to be placed near a perimeter wall 20 of the tabletop 14 away from the corners 22 occupied by the solar panels 26. Larger items may also be placed on the tabletop 14 which use the center portion 24 of the tabletop 14 and extend beyond the perimeter wall 20 of the tabletop 14 without obscuring the solar panels 26. The area of the upper surface 18 of the tabletop 14 in relation to the combined area of the solar panels 26 further facilitates more versatile use of the support apparatus 10 to support items as compared to prior art devices which use more significant sections of similar support surfaces for transformation of solar energy into electrical energy. The use of at least two spaced apart solar panels 26 allows for at least one solar panel 26 being unobscured by supported objects on the upper surface 18 of the tabletop 14 even if the supported objects obscure one or more other solar panels 26.

A power storage 30 is electrically coupled to the pair of solar panels 26 and comprises a battery 32. The power storage 30 is mounted in the tabletop 14. Each one of a pair of charging assemblies 34 is electrically coupled to the power storage 30. Each charging assembly 34 of the pair of charging assemblies 34 is mounted to the tabletop 14 adjacent to an associated solar panel 26 of the pair of solar panels 26. Each charging assembly 34 of the pair of charging assemblies 34 is positioned on opposing sections of the perimeter wall 20 of the tabletop 14 and comprises a pair of charging ports 36. The pair of charging ports 36 includes a Universal Serial Bus Type-A port 38 and a Universal Serial Bus Type-C port 40, but other suitable 12 charging ports 36 may be used.

In use, the upper surface 18 of the tabletop 14 is used to support objects while the solar panels 26 generate electricity from solar energy to charge the battery 32. The battery 32 is discharged by electrically coupling electronic devices 42 to at least one charging port 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A support apparatus for generating, storing, and discharging electrical power, the support apparatus comprising:
a table, the table having a tabletop and a plurality of legs, the plurality of legs being coupled to and extending downwardly from the tabletop, the tabletop having an upper surface which is configured for supporting items, the upper surface being planar;
a solar panel being coupled to the table and being positioned on the tabletop, the solar panel having a top surface which is coplanar with the upper surface of the tabletop, the solar panel being positioned in a corner of the tabletop;
a power storage being electrically coupled to the solar panel; and
a charging assembly being electrically coupled to the power storage, the charging assembly being mounted to the tabletop, the charging assembly comprising a charging port.

2. The apparatus of claim 1, wherein the upper surface has a square shape.

3. The apparatus of claim 1, wherein a width of the solar panel is less than 25.0% of a width of the upper surface of the tabletop.

4. The apparatus of claim 3, wherein a length of the solar panel taken perpendicularly to the width of the solar panel is less than 25.0% of a length of the upper surface of the tabletop taken perpendicularly to the width of the upper surface.

5. The apparatus of claim 1, wherein the power storage comprises a battery.

6. The apparatus of claim 4, wherein the power storage is mounted in the tabletop.

7. The apparatus of claim 1, wherein the charging port of the charging assembly is one of a pair of charging ports, the pair of charging ports including a Universal Serial Bus Type-A port and a Universal Serial Bus Type-C port.

8. A support apparatus for generating, storing, and discharging electrical power, the support apparatus comprising:
a table, the table having a tabletop and a plurality of legs, the plurality of legs being coupled to and extending downwardly from the tabletop, the tabletop having an upper surface which is configured for supporting items, the upper surface being planar, the upper surface having a square shape;
a pair of solar panels being coupled to the table, each solar panel of the pair of solar panels being positioned on the tabletop, each solar panel of the pair of solar panels having a top surface which is coplanar with the upper surface of the tabletop, the pair of solar panels being positioned in opposing corners of the tabletop, a width of each solar panel being less than 25.0% of a width of the upper surface of the tabletop, a length of each solar panel taken perpendicularly to the width of the solar panel being less than 25.0% of a length of the upper surface of the tabletop taken perpendicularly to the width of the upper surface;
a power storage being electrically coupled to the pair of solar panels, the power storage comprising a battery, the power storage being mounted in the tabletop; and
a pair of charging assemblies, each charging assembly of the pair of charging assemblies being electrically coupled to the power storage, each charging assembly of the pair of charging assemblies being mounted to the tabletop adjacent to an associated solar panel of the pair of solar panels, each charging assembly of the pair of charging assemblies being positioned on opposing sections of a perimeter wall of the tabletop, each charging assembly of the pair of charging assemblies comprising a pair of charging ports, the pair of charging ports including a Universal Serial Bus Type-A port and a Universal Serial Bus Type-C port.
